(19) United States
(12) Patent Application Publication
(10) Pub. No.: US 2007/0139512 A1
(43) Pub. Date: Jun. 21, 2007

(54) Communication terminal and communication method

(75) Inventors: Tetsu Hada, Kanagawa (JP); Hideaki Matsuo, Kanagawa (JP); Hiroki Nogoshi, Hokkaido (JP); Naoyuki Suzuki, Kanagawa (JP); Takahiro Makino, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 10/596,855

(22) PCT Filed: Mar. 31, 2005
(86) PCT No.: PCT/JP05/06313

§ 371 Date: Jun. 27, 2006

(30) Foreign Application Priority Data
Mar. 24, 2005 (JP) 2005-086335
Apr. 7, 2004 (JP) 2004-112854

(51) Int. Cl. H04N 7/14

(52) U.S. Cl. 348/14.01

(57) ABSTRACT

An object of the invention is to provide a communication terminal capable of causing an associated communication terminal to execute the function at the level required by the home terminal.

A communication terminal of the invention is a video telephone 1 having a communication function and installing a common function to a function that a video telephone 2 installs, and includes a display image generation section 13A for generating data to execute the function that the video telephone 1 installs and data to execute the function that the video telephone 2 installs, and a data transmission section 11A for transmitting the data to execute the function that the video telephone 2 installs.

### TECHNICAL FIELD

This invention relates to a communication terminal having a communication function and installing a common function to a function that an associated communication terminal installs and a communication method of the communication terminal.

### BACKGROUND ART

Hitherto, a video telephone provided with a function of sending a character called avatar to an associated communication terminal instead of a photograph image of the user has been developed (for example, refer to patent document 1).

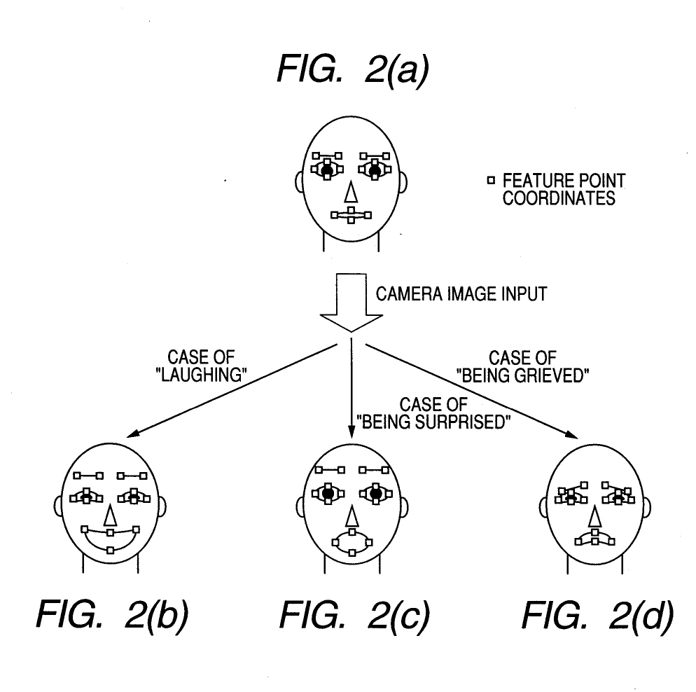

Patent document 1: JP-A-003-109036 (page 3, page 4, FIG. 2)

### DISCLOSURE OF THE INVENTION PROBLEMS THAT THE INVENTION IS TO SOLVE

However, in the video telephone in the related art, all video telephones have not necessarily the same processing capability and when communications are conducted between the video telephones different in processing capability, communications are conducted in accordance with the processing capability of the video telephone having the lower processing capability and smooth processing cannot be accomplished between the video telephones; this is a problem.

It is therefore an object of the invention to provide a communication terminal capable of causing an associated communication terminal to execute the function at the level required by the home terminal and a communication method of the communication terminal.

### MEANS FOR SOLVING THE PROBLEMS

The communication terminal of the invention is a communication terminal having a communication function and installing a common function to a function that an associated communication terminal installs, the communication terminal including data generation means for generating data to execute the function that the home terminal installs and data to execute the function that the associated communication terminal installs; and transmission means for transmitting the data to execute the function that the associated communication terminal installs.

According to the configuration, the data generation means for generating the data to execute the function that the home terminal installs and the data to execute the function that the associated communication terminal installs is provided, whereby if the terminal capability of the associated communication terminal is lower than that of the home terminal, the associated communication terminal can be caused to execute the function at the level required by the home terminal.

The communication terminal of the invention has a video telephone function; input data analysis means for analyzing input data; and data matching means for outputting data provided by matching the data of the home terminal and the data of the associated communication terminal based on the analysis result to the input data analysis means. The communication terminal of the invention includes input means for inputting at least one data selected from among image data, voice data, and key input data to the input data analysis means as the input data. According to the configuration, the input data analysis means for analyzing the input data is provided, whereby data on which the input data is reflected can be generated.

The communication method of the invention is a communication method of a communication terminal installing a common function to a function that an associated communication terminal installs, and includes the steps of generating data to execute the function that the home terminal installs and data to execute the function that the associated communication terminal installs; and transmitting the data to execute the function that the associated communication terminal installs.

### ADVANTAGES OF THE INVENTION

According to the invention, the data to execute the function that the home terminal installs and the data to execute the function that the associated communication terminal installs are generated, whereby if the terminal capability of the associated communication terminal is lower than that of the home terminal, the associated communication terminal can be caused to execute the function at the level required by the home terminal.

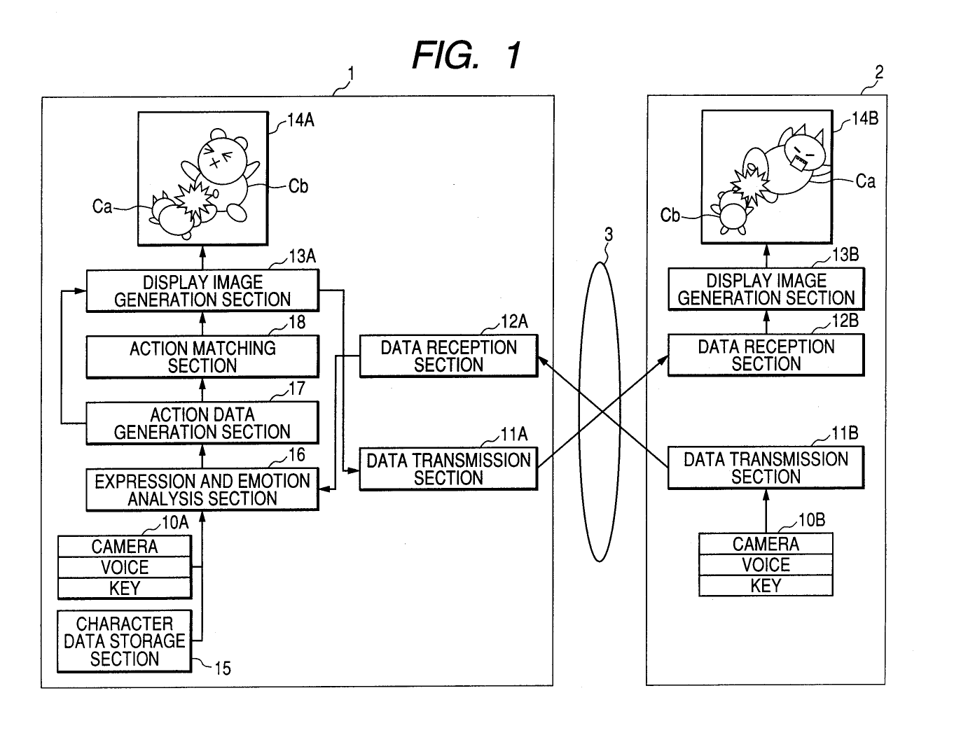

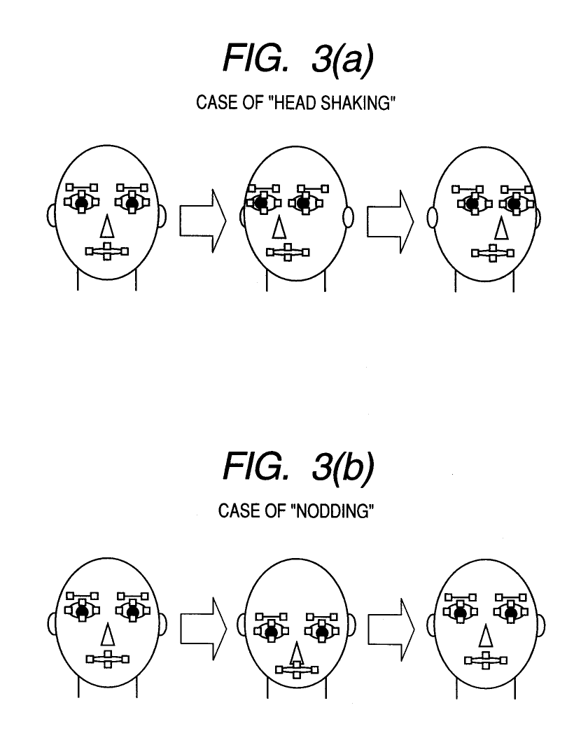

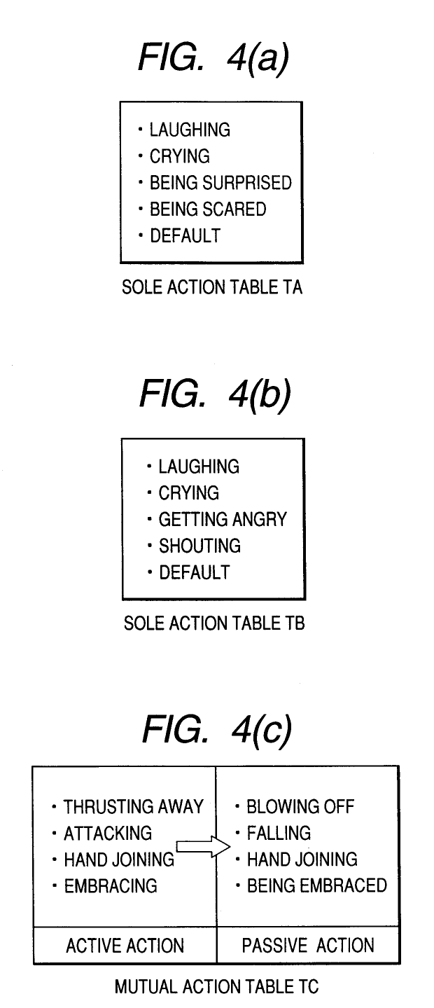

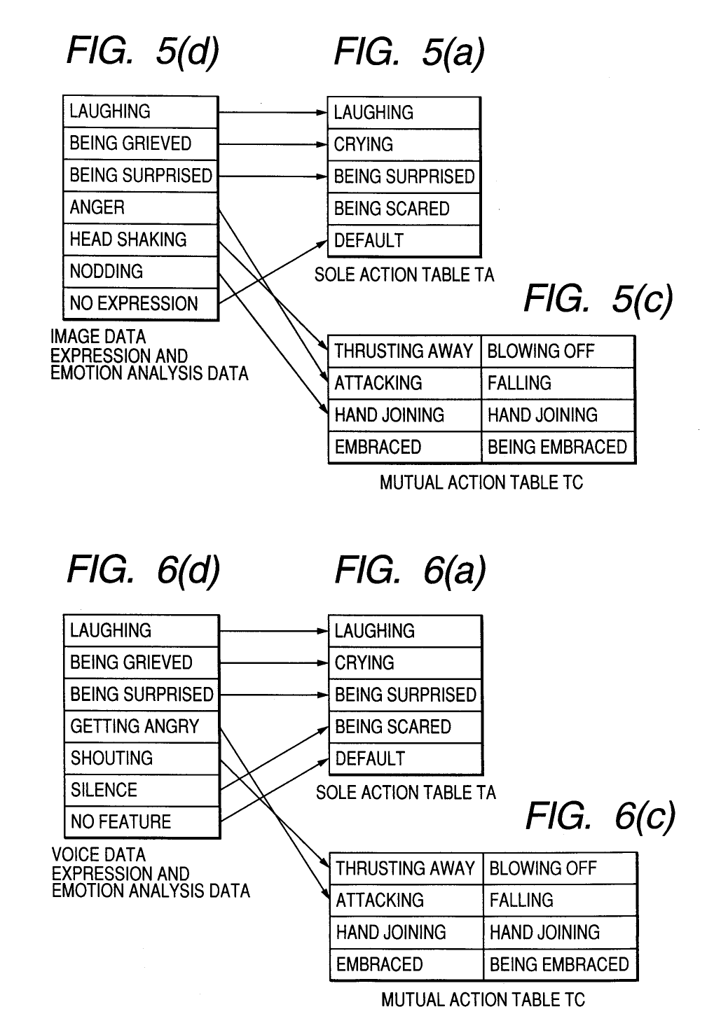

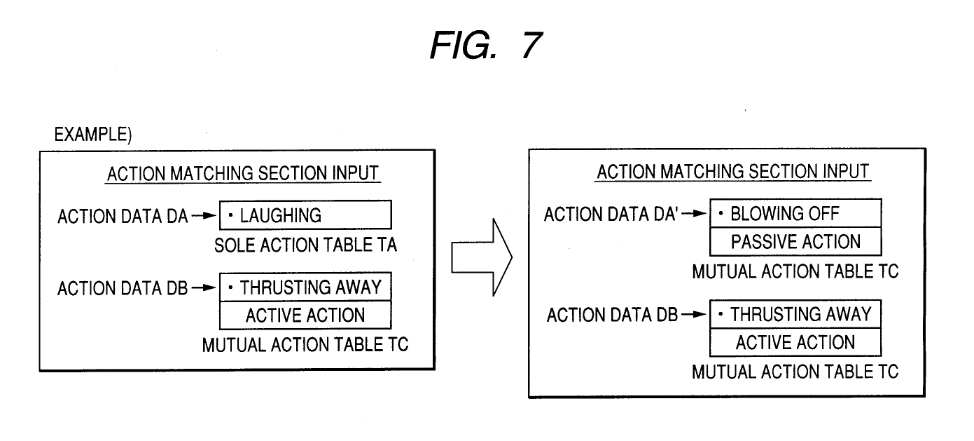

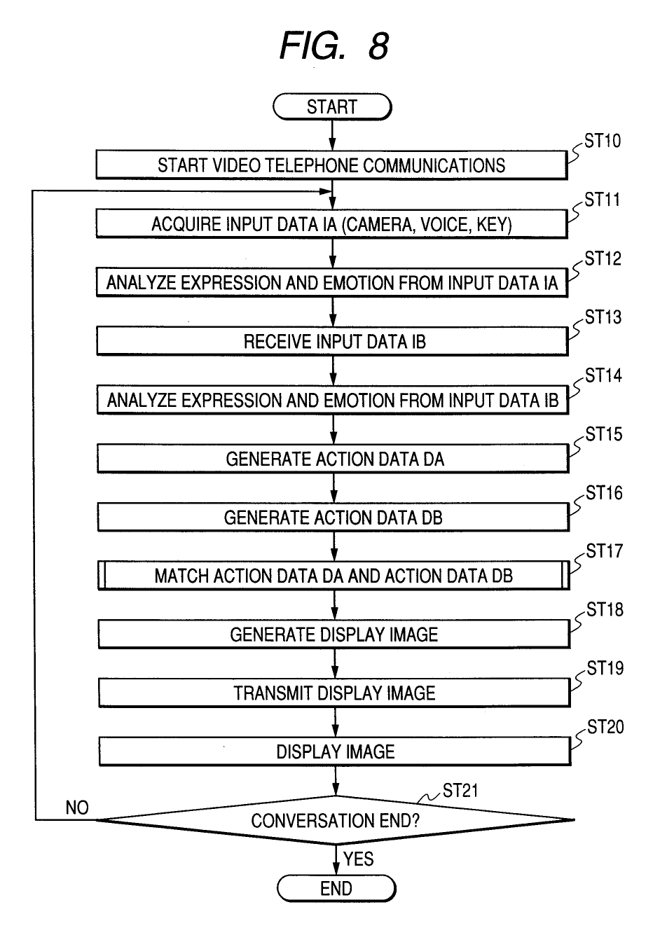

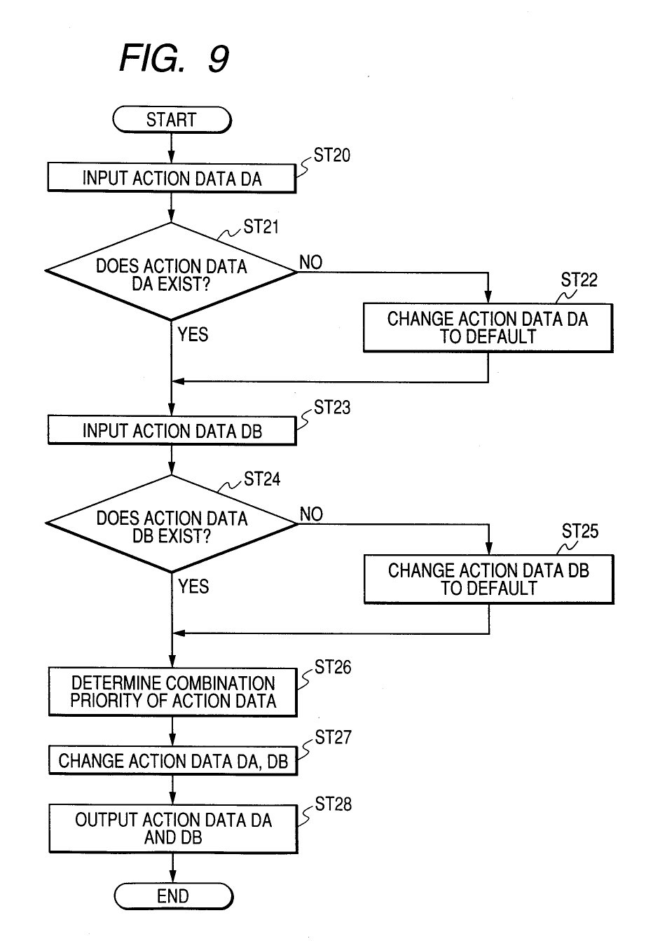

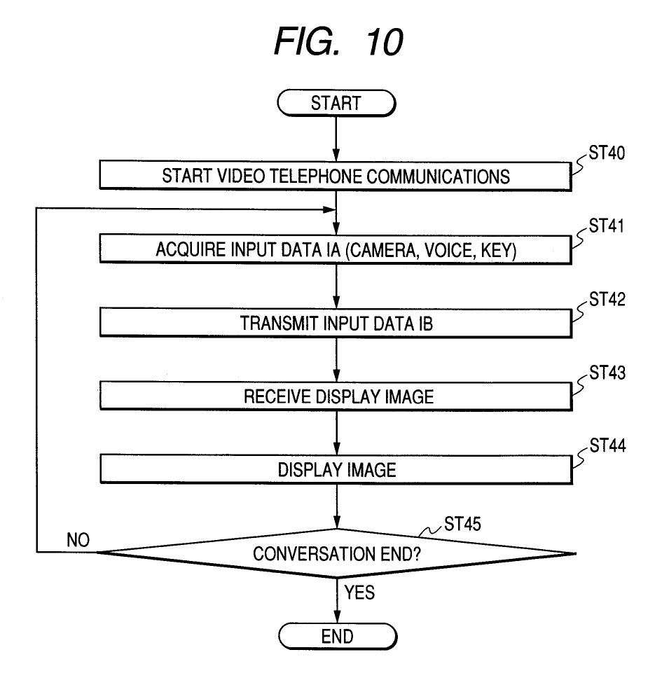

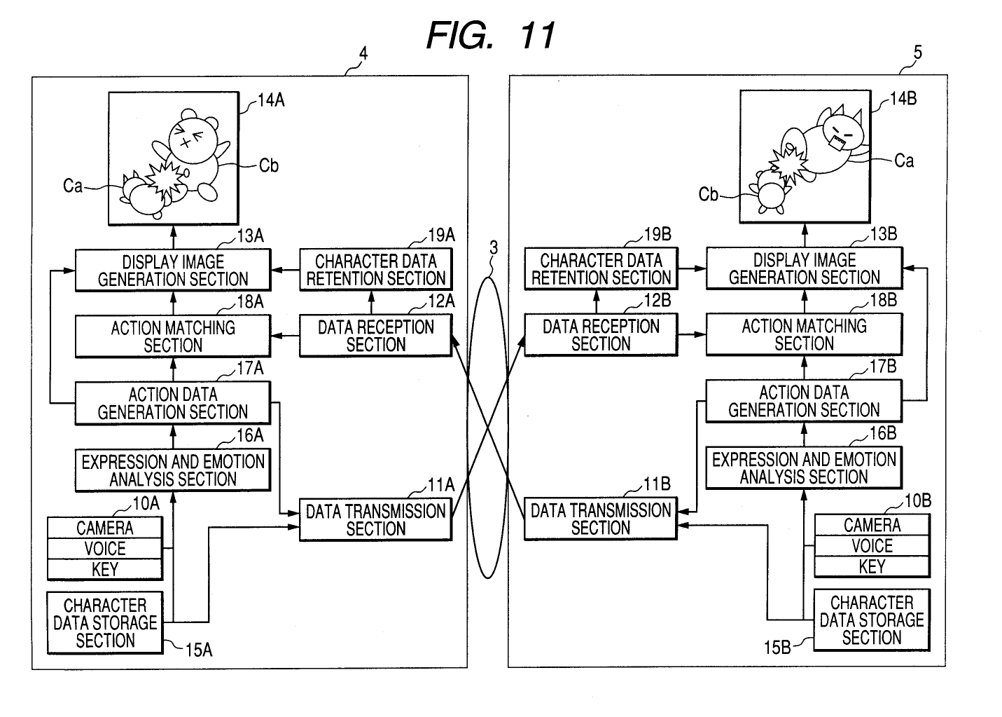

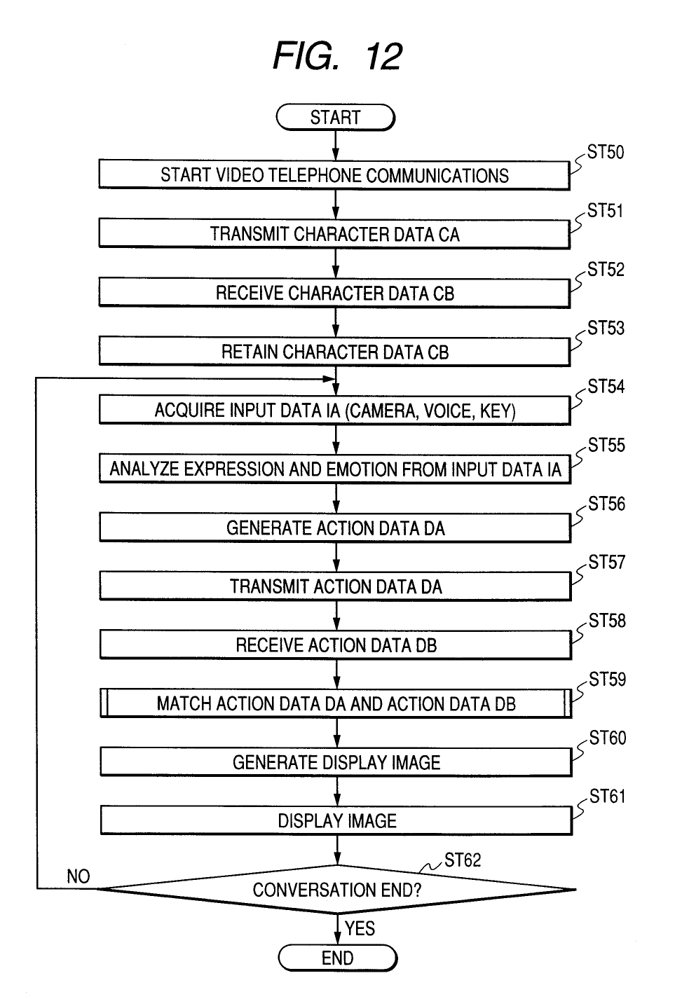

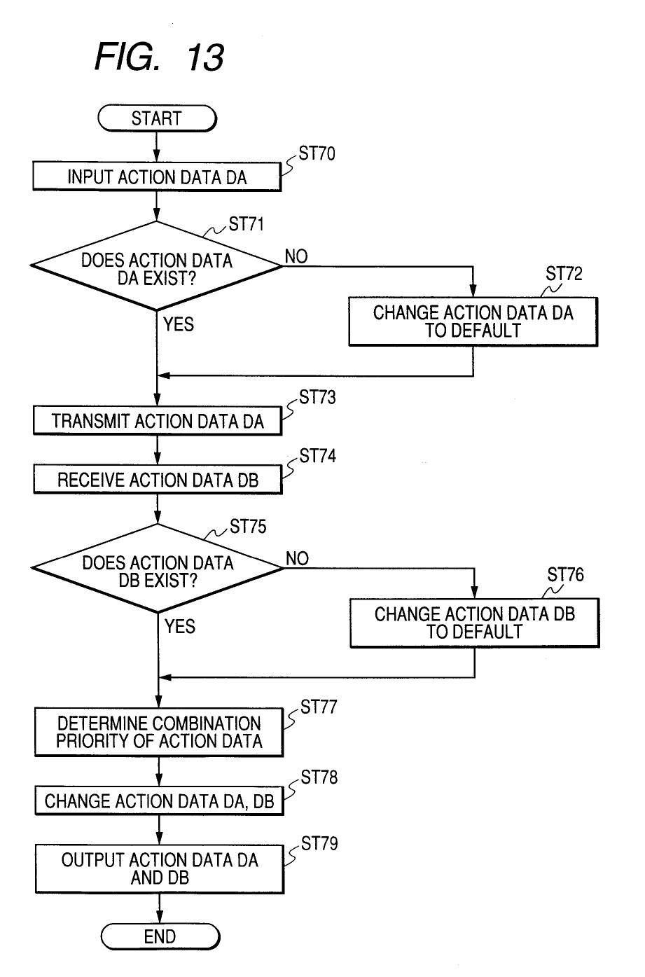

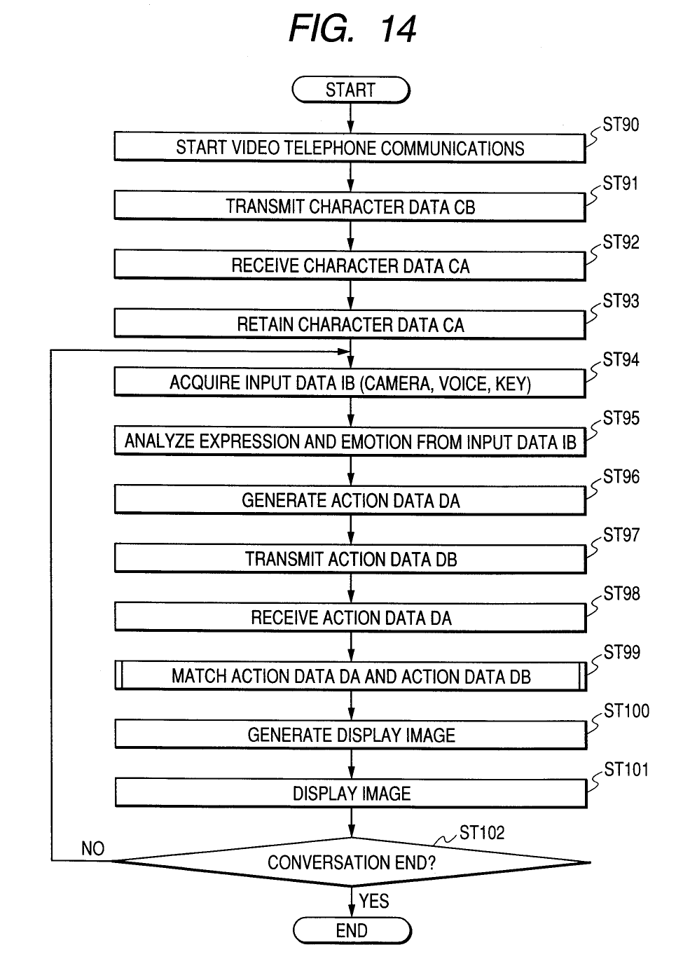

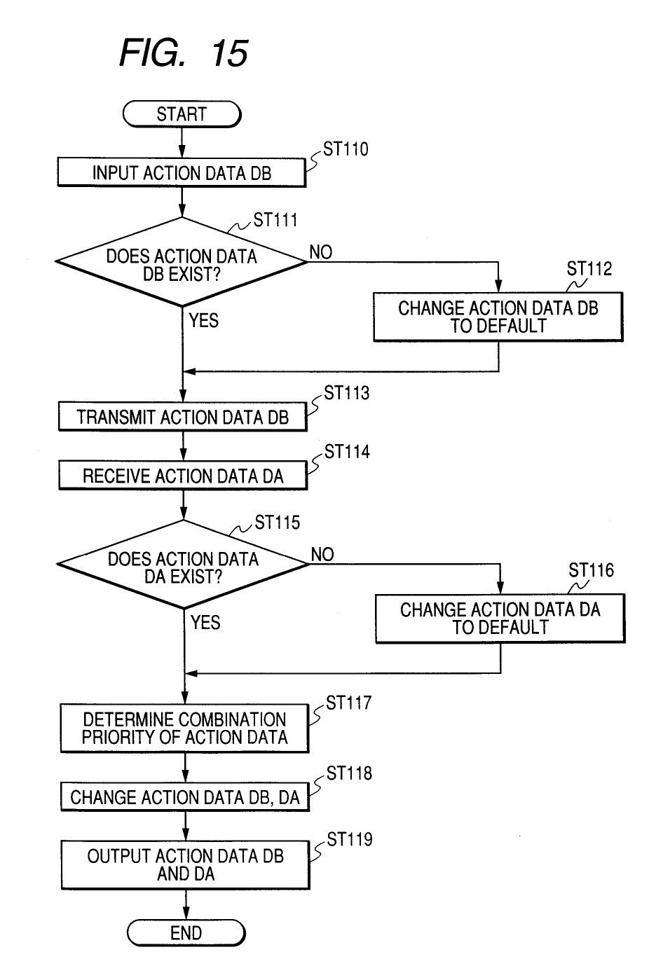

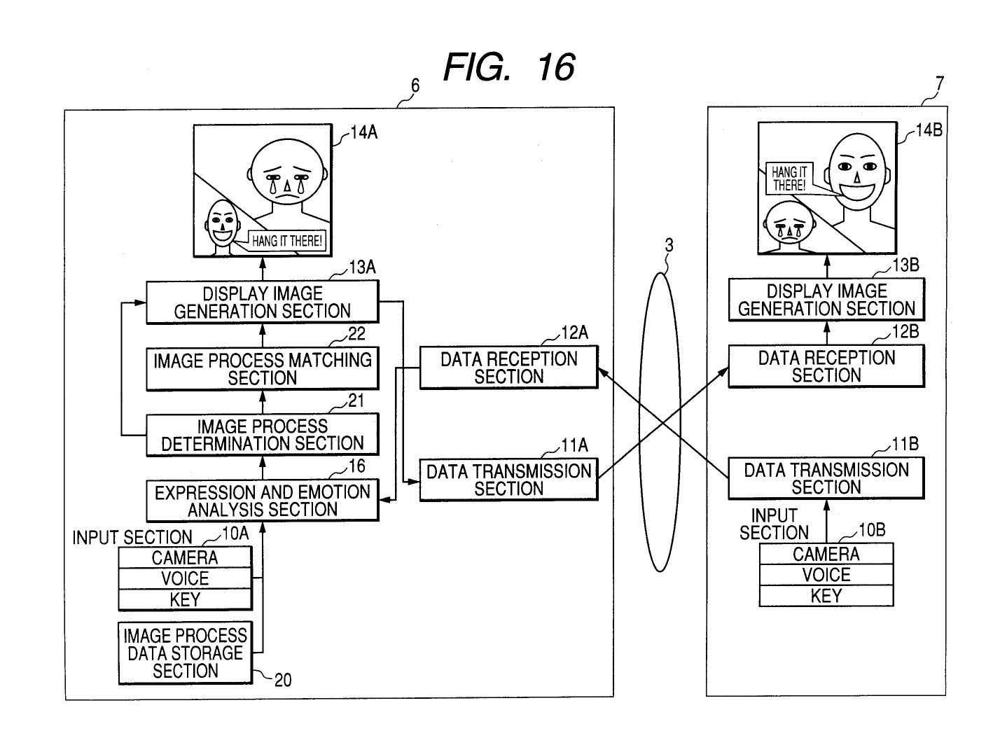

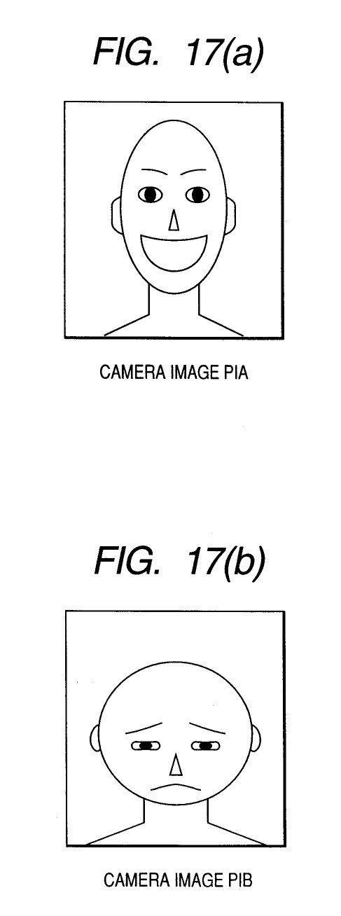

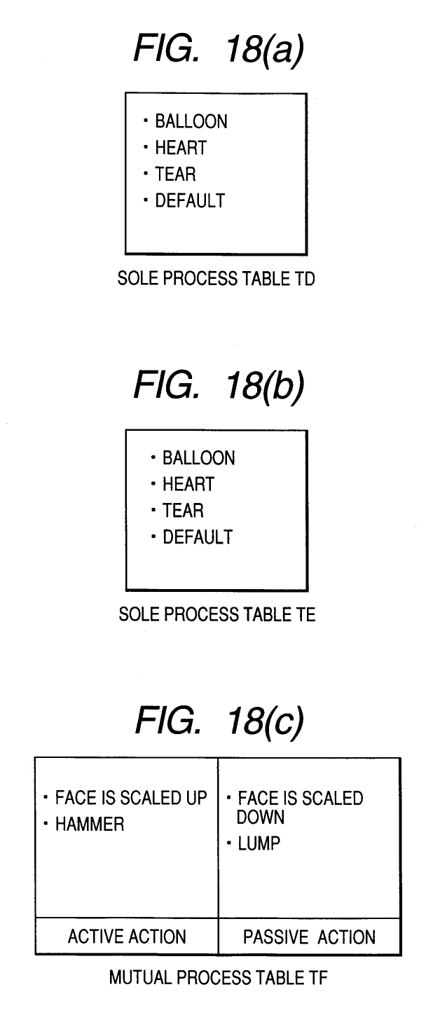

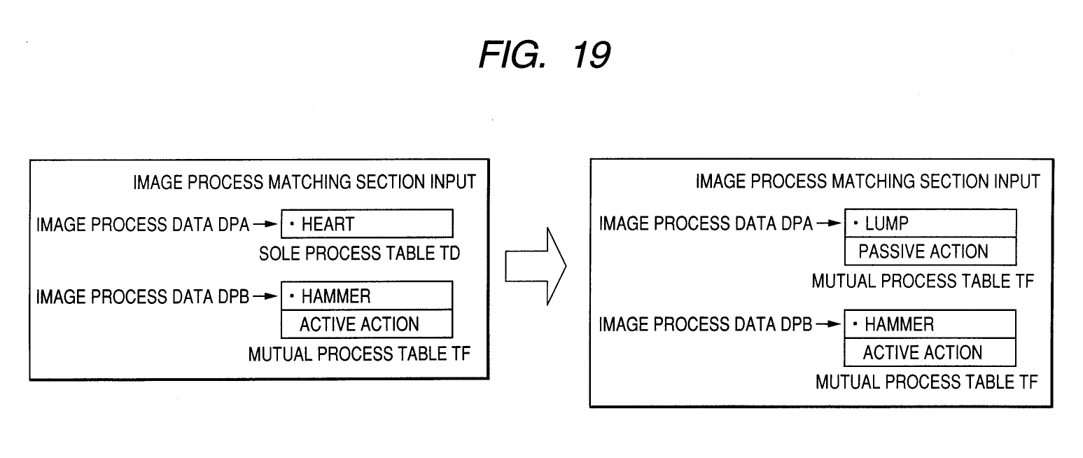

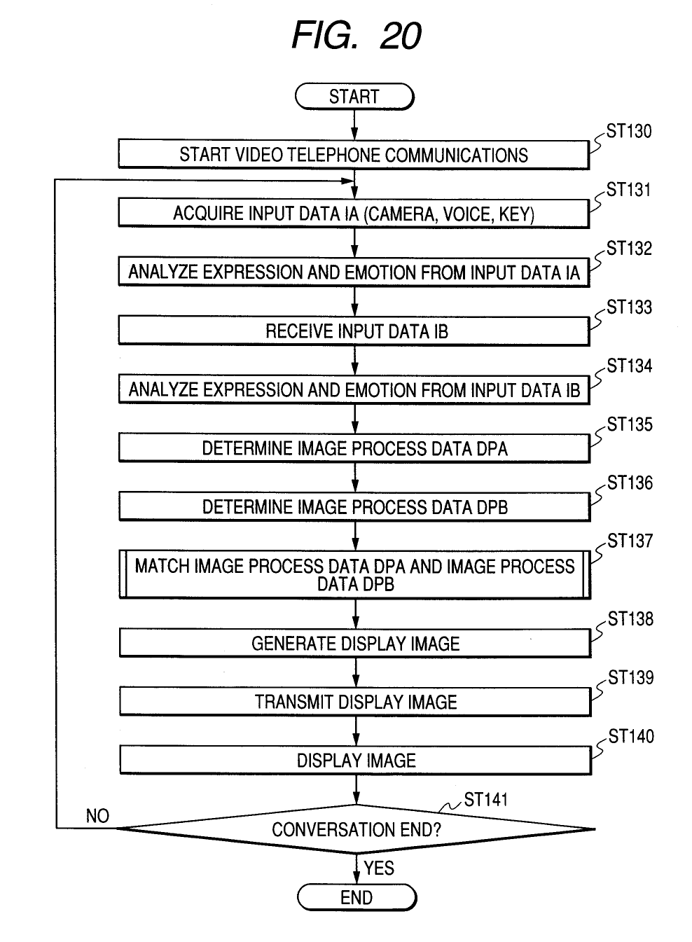

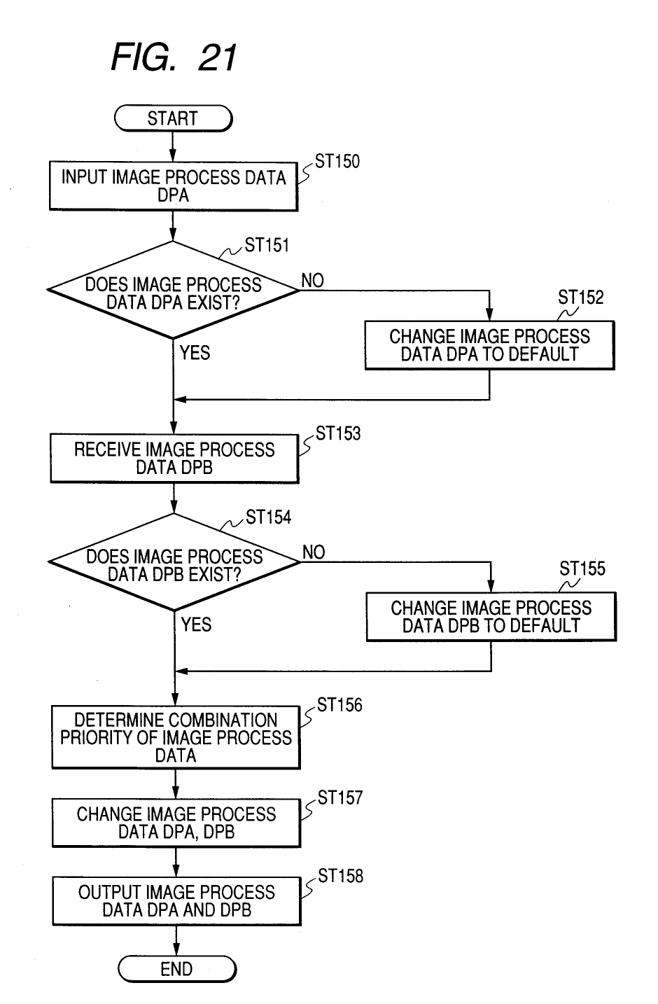

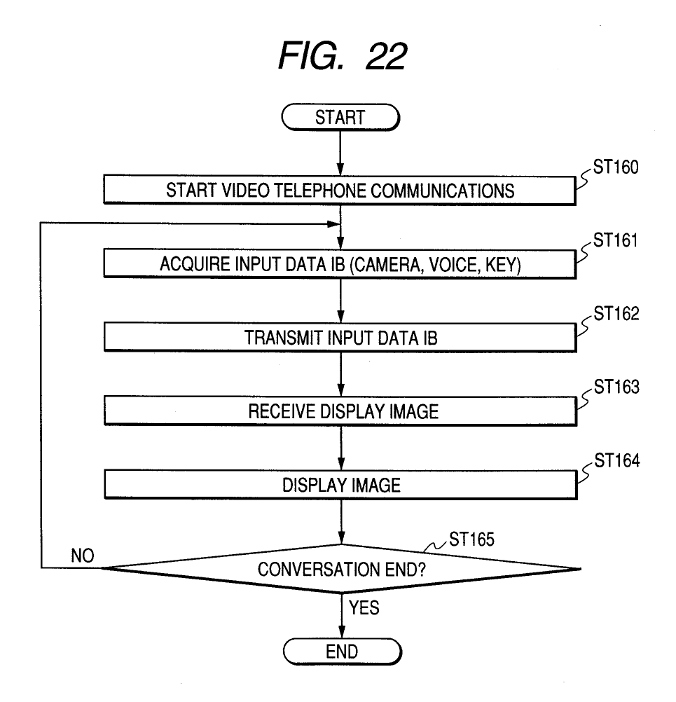

### BRIEF DESCRIPTION OF THE DRAWINGS

[FIG. 1] A schematic configuration diagram of a video telephone system to describe a first embodiment of the invention.

[FIG. 2] A drawing to show face recognition processing of an expression and emotion analysis section 16.

[FIG. 3] A drawing to show face recognition processing of the expression and emotion analysis section 16.

[FIG. 4] A drawing to show examples of action tables used by an action data generation section 17 and an action matching section 18.

[FIG. 5] A drawing (1) to show an operation outline of the action matching section 18.

[FIG. 6] A drawing (2) to show an operation outline of the action matching section 18.

[FIG. 7] A drawing (3) to show an operation outline of the action matching section 18.

[FIG. 8] A flowchart to show the operation of a video telephone 1.

[FIG. 9] A flowchart to show the operation of the action matching section 18.

[FIG. 10] A flowchart to show the operation of a video telephone 2.

[FIG. 11] A schematic configuration diagram of a video telephone system to describe a second embodiment of the invention.

[FIG. 12] A flowchart to show the operation of a video telephone 4.

[FIG. 13] A flowchart to show the operation of an action matching section 18A.

[FIG. 14] A flowchart to show the operation of a video telephone 5.

[FIG. 15] A flowchart to show the operation of an action matching section 18B.

[FIG. 16] A schematic configuration diagram of a video telephone system to describe a third embodiment of the invention.

[FIG. 17] A drawing to show images photographed with video telephones 6 and 7.

[FIG. 18] A drawing to show examples of action tables used by an image process determination section 21 and an image process matching section 22.

[FIG. 19] A drawing to show an operation outline of the image process matching section 22.

[FIG. 20] A flowchart to show the operation of the video telephone 6.

[FIG. 21] A flowchart to show the operation of the image process matching section 22.

[FIG. 22] A flowchart to show the operation of the video telephone 7.

### DESCRIPTION OF REFERENCE NUMERALS

1, 2, 4, 5, 6, 7 Video telephone
3 Network
10A, 10B Input data section
11A, 11B Data transmission section
12A, 12B Data reception section
13A, 13B Display image display section
15, 15A, 15B Character data storage section
16A, 16B Expression and emotion analysis section
17, 17A, 17B Action data generation section
18, 18A, 18B Action matching section
19A, 19B Character data retention section
20 Image process data storage section
21 Image process determination section
22 image process matching section

### BEST MODE FOR CARRYING OUT THE INVENTION

### FIRST EMBODIMENT

FIG. 1 is a schematic configuration diagram of a video telephone system to describe a first embodiment of the invention. The video telephone system shown in FIG. 1 includes video telephones 1 and 2 which have a communication function, install a common function to a function that an associated communication terminal installs, and differ in terminal capability, and enables them to communicate with each other through a network 3. For example, IP (Internet Protocol) is used for communications between the video telephones 1 and 2. In the embodiment, the case where the terminal capability of the video telephone 1 is higher than that of the video telephone 2 will be discussed. It is assumed that the video telephone 1 has a function of generating a character used common to the video telephone 2 (character used as user's alter ego called avatar) and a character is displayed instead of the facial image of the image during the conversation with the video telephone 2. In the description to follow, parts common to the video telephones 1 and 2 are denoted by the same reference numerals and further “A” is added to the parts of the video telephone 1 and “B” is added to the parts of the video telephone 2 to distinguish between the video telephones 1 and 2.

The video telephones 1 and 2 have input data sections 10A and 10B, data transmission sections 11A and 11B, data reception sections 12A and 12B, display image generation sections 13A and 13B, and video telephone display sections 14A and 14B as common parts. The video telephone 1 further has a character data storage section 15, an expression and emotion analysis section 16, an action data generation section 17, and an action matching section 18. The display image generation section 13A of the video telephone 1 generates data to execute the function that the video telephone 1 (home terminal) installs and data to execute the function that the video telephone 2 (associated communication terminal) installs, and the data transmission section 11A transmits the data to execute the function that the video telephone 2 installs. The expression and emotion analysis section 16 of the video telephone 1 analyzes the input data, and the action data generation section 17 outputs the data provided by matching the data of the video telephone 1 and the data of the video telephone 2 based on the analysis result to the display image generation section 13A. The input data section 10A of the video telephone 1 inputs any one selected from among image data, voice data, and key input data as input data into the expression and emotion analysis section 16.

The input data sections 10A and 10B are connected to various input means such as a camera, a microphone, and a key input section (not shown), and are used to acquire information representing user's expression, emotion, and action (user information). The input data section 10B of the video telephone 2 inputs any one selected from among image data, voice data, and key input data as input data into the expression and emotion analysis section 16 through the data transmission section 11B and the data reception section 12A. The data transmission section 11A transmits the image data to be displayed on the video telephone 2. The data transmission section 11B transmits information representing the expression and emotion of the user of the video telephone 2 to the video telephone 1. The data reception section 12A receives the information representing the expression and emotion of the user of the video telephone 2 transmitted from the video telephone 2. The data reception section 12B receives the image data transmitted from the video telephone 1.

The display image generation section 13A generates an image to be displayed on the video telephone display section 14A and an image to be displayed on the video telephone display section 14B based on the input data from the input data section 10A and the input data from the input data section 10B. The display image generation section 13A passes the generated image data to be displayed on the video telephone display section 14B to the data transmission section 11A.

The display image generation section 13B generates a display image from the image data generated by the display image generation section 13A and acquired through the data reception section 12B. The display image generation section 13B may display the acquired image data intact on the video telephone display section 14B without processing the image data. The video telephone display section 14A has a liquid crystal display and displays the image generated by the display image generation section 13A. The video telephone display section 14B has a liquid crystal display and displays the image generated by the display image generation section 13B. Data to create a character image is stored in the character data storage section 15. The character data is image data to display a character on the video telephones 1 and 2, and a plurality of pieces of the character data are provided corresponding to pieces of action data generated by the action data generation section 17. In the embodiment, two types of characters can be displayed.

The expression and emotion analysis section 16 analyzes the expression and emotion of the user of the video telephone 1 based on the image data, the voice data, or the key input data from the input data section lA. The expression and emotion analysis section 16 also analyzes the expression and emotion of the user of the video telephone 2 based on the image data, the voice data, or the key input data from the video telephone 2. If the facial image of the user is input, the expression and emotion analysis section 16 analyzes the facial image and detects the expression and emotion of laughing, being angered, etc.

As a method of detecting the expression and emotion, for example, face recognition processing is performed from the image input data acquired periodically and the average values of the feature point coordinates of the face parts of eyebrows, eyes, a mouth, etc., detected are found as average expression feature point coordinates. A comparison is made between the feature point coordinates of the face parts of the eyebrows, the eyes, the mouth, etc., undergoing the face recognition processing according to the image input data acquired this time and the average expression feature point coordinates and if change in each face part satisfied a specific condition, the expression and emotion of “laughing,” “being surprised,” “being grieved,” etc., are detected. FIG. 2 is a drawing to schematically show the face recognition processing for the cases of “laughing,” “being surprised,” and “being grieved.” In the figure, “□” indicates the detection point by the face recognition processing and a plurality of detection points are set for each of the eyebrows, the eyes, and the mouth. FIG. 2(a) shows the average expression feature point coordinates provided by the face recognition processing for each frame. FIG. 2(b) shows the expression feature point coordinates of the case of “laughing,” FIG. 2(c) shows the expression feature point coordinates of the case of “being surprised,” and FIG. 2(d) shows the expression feature point coordinates of the case of “being grieved.”

In the case of “laughing,” three conditions that both ends of the eyebrow change upward a threshold value W3 or more, that the lower end of the eye changes upward a threshold value W2 or more, and that both ends of the mouth change upward a threshold value W1 or more are all satisfied. In the case of “being surprised,” three conditions that both ends of the eyebrow change upward a threshold value O1 or more, that the top and bottom width of the eye increases a threshold value N2 or more, and that the top and bottom width of the mouth increases a threshold value N3 or more are all satisfied. In the case of “being grieved,” three conditions that both ends of the eyebrow change downward a threshold value Ni or more, that the top and bottom width of the eye decreases a threshold value N2 or more, and that both ends of the mouth change downward a threshold value N3 or more are all satisfied.

The expression and emotion analysis section 16 detects face motion for a given time, thereby detecting action of “head shaking,” “nodding,” etc. FIG. 3 is a drawing to schematically show the face recognition processing for the cases of “head shaking” and “nodding.” In the figure, “□” indicates the detection point by the face recognition processing and a plurality of detection points are set for each of the eyebrows, the eyes, and the mouth as in the example described above. FIG. 3(a) shows change in the expression feature point coordinates of the case of “head shaking.” FIG. 3(b) shows change in the expression feature point coordinates of the case of “nodding.” In the case of “head shaking,” two conditions that the expression feature point coordinates change a threshold value K1 or more in a lateral direction from the face center and that the expression feature point coordinates change a threshold value K2 or more in an opposite direction from the face center are satisfied. In the case of “nodding,” two conditions that the expression feature point coordinates change a threshold value U1 or more downward from the face center and that the expression feature point coordinates change a threshold value U2 or more upward from the face center are satisfied.

The expression and emotion analysis section 16 analyzes the key input data and detects the expression and emotion associated with each key. Here, various expressions and emotions are associated with the keys of a key operation section (not shown) and as the user operates (presses) the key matching his or her expression and emotion during telephone conversation, the expression and emotion analysis section 16 detects the expression and emotion and determines the action corresponding to the expression and emotion. For example, the expression and emotion of “getting angry” are associated with a key of “1” and the user presses the key, whereby the action of “getting angry” is confirmed. The expression and emotion of “laughing” are associated with a key of “2” and the user presses the key, whereby the action of “laughing” is confirmed. The expression and emotion of “being surprised” are associated with a key of “3” and the user presses the key, whereby the action of “being surprised” is confirmed. The expression and emotion of “being scared” are associated with a key of “4” and the user presses the key, whereby the action of “being scared” is confirmed.

The action of “hand raising” is associated with a key of “5” and the user presses the key, whereby the action of “hand raising” is confirmed. The action of “thrusting away” is associated with a key of “6” and the user presses the key, whereby the action of “thrusting away” is confirmed. The action of “attacking” is associated with a key of “7” and the user presses the key, whereby the action of “attacking” is confirmed. The action of “hand joining” is associated with a key of “8” and the user presses the key, whereby the action of “hand joining” is confirmed. The action of “embracing” is associated with a key of “9” and the user presses the key, whereby the action of “embracing” is confirmed.

From the expression and emotion detected by the face recognition processing described above, the action is associated with a sole action table or a mutual action table by performing expression and emotion conversion processing, and the action of “laughing,” “being surprised,” “head shaking,” “nodding,” “hand joining,” or “embracing” of the character is confirmed.

The expression and emotion analysis section 16 analyzes voice data and detects the emotion of yelling, etc., of the user. As a method of detecting the emotion, the user's emotion is detected from magnitude change in the rhythm and sound, for example, in such a manner that if the rhythm of voice input data becomes fast and the sound becomes large, “laughing” is confirmed, that if the rhythm is unchanged and the sound becomes large, “being surprised” is confirmed, or that if the rhythm is slow and the sound becomes small, “being grieved” is confirmed. From the detected emotion, the action is associated with the sole action table or the mutual action table by performing expression and emotion conversion processing, and the action of “laughing,” “being surprised,” “being grieved,” “hand joining,” or “embracing” of the character is confirmed.

Thus, the expression and emotion analysis section 16 analyzes the expression and emotion of the user based on the image data, the voice data, and the key input data, and inputs the analysis result to the action data generation section 17. All of the image data, the voice data, and the key input data are not required and any one of them may be used.

FIG. 4 is a drawing to show examples of action tables used by the action data generation section 17 and the action matching section 18. The action data generation section 17 references the tables shown in FIG. 4 based the analysis result of the expression and emotion analysis section 16 and generates action data responsive to the expressions and emotions of the user of the video telephone 1 and the user of the video telephone 2. FIG. 4(a) is a sole action table TA of the video telephone 1 and shows a set of sole action data of a character Ca. FIG. 4(b) is a sole action table TB of the video telephone 2 and shows a set of sole action data of a character Cb. FIG. 4(c) is a mutual action table TC of the video telephones 1 and 2 and shows a set of action data affecting the associated character Ca or Cb.

The action data generation section 17 generates action data DA from the sole action table TA if input data IA of the video telephone 1 indicates sole action; generates action data DB from the sole action table TB if input data IB of the video telephone 2 indicates sole action; generates action data DA from the mutual action table TC if input data IA of the video telephone 1 indicates mutual action; and generates action data DB from the mutual action table TC if input data IB of the video telephone 2 indicates mutual action.

FIG. 5 shows the relationship between image data and the action data DA when image data is input as the input data IA in the video telephone 1 byway of example. In this case, action of the video telephone 1 is applied and thus the sole action table TA in FIG. 5(a) (FIG. 4(a)) and the mutual action table TC in FIG. 5(c) (FIG. 4(c)) are used. FIG. 5(d) is a drawing to show an example of an expression and emotion analysis table used by the expression and emotion analysis section 16. The analysis result of the expression and emotion analysis section 16 is temporarily retained in the expression and emotion analysis table.
(1) If the input data IA of the video telephone 1 is image data indicating the emotion of “laughing,” the action data DA of “laughing” is generated.
(2) If the input data IA of the video telephone 1 is image data indicating the emotion of “being grieved,” the action data DA of “crying” is generated.
(3) If the input data IA of the video telephone 1 is image data indicating the emotion of “being surprised,” the action data DA of “being surprised” is generated.
(4) If the input data IA of the video telephone 1 is image data indicating the action of “angry,” the action data DA of “attacking” is generated.
(5) If the input data IA of the video telephone 1 is image data indicating the action of “head shaking,” the action data DA of “thrusting away” is generated.
(6) If the input data IA of the video telephone 1 is image data indicating the action of “nodding,” the action data DA of “hand joining” is generated.

FIG. 6 shows the relationship between voice data and the action data DA when voice data is input as the input data IA in the video telephone 1. Also in this case, action of the video telephone 1 is applied and thus the sole action table TA in FIG. 6(a) (FIG. 4(a)) and the mutual action table TC in FIG. 6(c) (FIG. 4(c)) are used.
(1) If the input data IA of the video telephone 1 is voice data indicating the emotion of “laughing,” the action data DA of “laughing” is generated.
(2) If the input data IA of the video telephone 1 is voice data indicating the emotion of “being grieved,” the action data DA of “crying” is generated.
(3) If the input data IA of the video telephone 1 is voice data indicating the emotion of “being surprised,” the action data DA of “being surprised” is generated.
(4) If the input data IA of the video telephone 1 is voice data indicating the emotion of “getting angry,” the action data DA of “attacking” is generated.
(5) If the input data IA of the video telephone 1 is voice data indicating the emotion of “shouting,” the action data DA of “thrusting away” is generated.
(6) If the input data IA of the video telephone 1 is voice data indicating the emotion of “silence,” the action data DA of “being scared” is generated.

Although the example described above applies to the video telephone 1, similar description also applies to the video telephone 2 regardless of whether the input data IB is image or voice. This means that the input data IA of the video telephone 1 is replaced with the input data IB and the action data DA is replaced with the action data DB. Of course, the sole action table TB in FIG. 4(b) and the mutual action table TC in FIG. 4(c) are used for the video telephone 2.

The action data generation section 17 inputs the action data DA, DB generated as described above to the display image generation section 13A and the action matching section 18. The action matching section 18 matches the action data DA and DB as follows:
(1) If both the action data DA and the action data DB are sole action data, the action data DA and the action data DB are output intact (example: Character Ca “laughs” and character Cb “cries”)

FIG. 7 is a drawing to show an operation outline of the action matching section and shows an operation outline of the action matching section 18 for the case shown in (2).
(2) If the action data DA is sole action data and the action data DB is mutual action data, the action data DB takes precedence over the action data DA. As the action data DB, the active action data in the mutual action table TC is output and as the action data DA, the passive action data corresponding to the active action data in the mutual action table TC is output (example: If character Cb “thrusts away,” character Ca “blows off”). As shown in FIG. 7, before action matching is performed, the action data DA is “laughing” and the action data DB is “thrusting away” and the action data DB of mutual action takes precedence over the action data DA and thus the action data DA of “laughing” becomes action data DA′ of “blowing off.”
(3) If the action data DA is mutual action data and the action data DB is sole action data, the action matching section 18 operates as in (2) (example: If character Cb “thrusts away,” character Ca “blows off”).
(4) If both the action data DA and the action data DB are mutual action data, for example, the data acquired earlier takes precedence and the action data of mutual action on the superior side is output (example: If the action data DA takes precedence, when character Ca “attacks,” character Cb “falls”).

When input data from the expression and emotion analysis section 16 does not exist (none of image data, voice data, and key input data are input), the action data generation section 17 generates action data of “default action” in the sole action table TA, TB as shown in FIGS. 5 and 6.

The display image generation section 13A acquires the character data corresponding to the action data DA generated by the action data generation section 17 or the action data DA′ provided by matching the action data DA by the action matching section 18 from the character data storage section 15 and displays the image on the video telephone display section 14A. It also acquires the character data corresponding to the action data DB for the video telephone 2 generated by the action data generation section 17 or the action data DB′ provided by matching the action data DB by the action matching section 18 from the character data storage section 15 and transmits the character data through the data transmission section 11A to the video telephone 2.

For example, if the action data DA of mutual action of “thrusting away” and the action data DB of sole action of “laughing,” “crying,” “being surprised,” or “being scared” are generated, display based on the action data DA is produced on the video telephone display section 14A, namely, a character image where the character Ca of the video telephone 1 thrusts the character Cb of the video telephone 2 away is displayed as shown in FIG. 1, and display based on the action data DB′ provided by matching is produced on the video telephone display section 14B, namely, a character image where the character Cb of the video telephone 2 is thrust away by the character Ca of the video telephone 1 is displayed as shown in FIG. 1.

If the action data DB is action data of mutual action and occurs later than the action data DA, the character images displayed on the video telephone display section 14A and the video telephone display section 14B in FIG. 1 become similar. This description, however, does not apply to the case where the precedence is not determined before and after the time.

FIG. 8 is a flowchart to show the operation of the video telephone 1. First, the video telephone 1 starts conversation with the video telephone 2 (ST10). When the conversation with the video telephone 2 is started, input data IA is acquired from the input data section 10A (ST11). That is, at least one of image data, voice data, and key input data is acquired. Next, the expression and emotion of the user of the video telephone 1 are analyzed from the acquired input data IA (ST12). For example, if a laughing face of the user of the video telephone 1 is photographed, the analysis result of “laughing” is produced.

After the expression and emotion are analyzed from the input data IA, reception of input data IB from the video telephone 2 is started (ST13). When the input data IB transmitted from the video telephone 2 is received, the expression and emotion of the user of the video telephone 2 are analyzed from the input data IB (ST14). For example, if a crying face of the user of the video telephone 2 is fetched, the analysis result of “crying” is produced. Action data DA is generated from the analysis result of the input data IA (ST15) and subsequently action data DB is generated from the analysis result of the input data IB (ST16).

After the action data DA and DB are generated, if one of them is data of mutual action, matching is performed (ST17). If both are data of mutual action, matching is performed so that the action data based on the input data occurring earlier becomes active action. After the action data DA and DB are matched, the display images of the characters to be displayed on the video telephone display sections 14A and 14B are generated (ST18). The display image data of the character for the video telephone 2 is transmitted to the video telephone 2 (ST19). After the display image data of the character is transmitted to the video telephone 2, the display image of the character for the video telephone 1 is displayed on the video telephone display section 14A (ST20). During the telephone conversation (NO at ST21), steps ST11 to ST20 are repeated. When the telephone conversation terminates (YES at ST21), the processing is terminated.

FIG. 9 is a flowchart to show the operation of the action matching section 18. First, the action matching section 18 receives input of action data DA (ST20) and determines whether or not action data DA exists (ST21). If action data DA does not exist (NO at ST21), the action data DA is changed to default action data DA (ST22). In contrast, if action data DA exists (YES at ST21), input of action data DB is received (ST23) and whether or not action data DB exists is determined (ST24). If action data DB does not exist (NO at ST24), the action data DB is changed to default action data DB (ST25).

In contrast, if action data DB exists (YES at ST24), the combination priority of the action data DA and DB is determined (ST26). In this case, mutual action takes precedence over sole action and for mutual actions, for example, the mutual action corresponding to the earlier acquired input data is selected. After the combination priority of the action data DA and DB is determined, the action data DA, DB is changed according to the priority (ST27). That is, as described above, if the action data DA is “laughing” and the action data DB is “thrusting away,” the action data DB of mutual action takes precedence over the action data DA and accordingly, the action data DA of “laughing” is changed to action data DA′ of “blowing off.” After the action data DA, DB is changed, they are output (ST28).

FIG. 10 is a flowchart to show the operation of the video telephone 2. First, the video telephone 2 starts conversation with the video telephone 1 (ST40). When the conversation with the video telephone 1 is started, input data IB is acquired from the input data section 10B (ST41). That is, at least one of image data, voice data, and key input data is acquired. Next, the acquired input data IB is transmitted to the video telephone 1 (ST42). After the input data IB is transmitted to the video telephone 1, character display image data is received (ST43). If the character display image data transmitted from the video telephone 1 can be received, the character display image is displayed on the video telephone display section 14B (ST44). During the telephone conversation (NO at ST45), steps ST41 to ST45 are repeated. When the telephone conversation terminates (YES at ST45), the processing is terminated.

Thus, according to the video telephone system described above, the video telephone 1 generates the image data to be displayed on the associated communication terminal (video telephone 2) in addition to the image data displayed on the home terminal and transmits the image data to be displayed on the video telephone 2 to the video telephone 2, whereby if the terminal capability of the associated communication terminal is lower than that of the home terminal, the associated communication terminal can be caused to execute the function at the level required by the home terminal.

In the description given above, the video telephone 1 has the character data to be displayed on the video telephones 1 and 2, but the character data may be transmitted from the video telephone 2 to the video telephone 1 at the telephone conversation start time. In the description given above, the image data corresponding to the action is acquired from the character data storage section 15 and is transmitted to the video telephone 2, but the character data on which the image is to be displayed is based may be transmitted at the telephone conversation start time and only the difference data corresponding to the character action may be transmitted during the telephone conversation. Accordingly, the data communication amount can be decreased as compared with the case where all image data is transmitted during the telephone conversation as in the related art.

In the embodiment described above, as the sole actions, “laughing,” “crying,” “being surprised,” “being scared,” “getting angry,” and “shouting” are taken as examples and as the mutual actions, “thrusting away” —>“blowing off,” “attacking” —>“falling,” “hand joining” —>“hand joining,” and “embracing” —>“being embraced” are taken as examples, but the invention is not limited to them and various examples can be named. The sole action data can also be used as the mutual action data. For example, “being surprised” can be set to mutual action with “shouting.”

In the embodiment described above, to confirm the action by key operation, if the user simply operates (presses) a key, the action assigned to the key is confirmed, but a new action may be able to be confirmed depending on a key operation manner (of continuing to press the key, intermittently pressing the key, accentually pressing the key, etc., for example).

### SECOND EMBODIMENT

FIG. 11 is a schematic configuration diagram of a video telephone system to describe a second embodiment of the invention. The video telephone system shown in FIG. 11 includes video telephones 4 and 5 which have a communication function, install a common function to a function that an associated communication terminal installs, and have the same degree of terminal capability. Parts common to those in FIG. 1 are denoted by the same reference numerals in FIG. 11 and the video telephones include each a character data storage section, an expression and emotion analysis section, an action data generation section, and an action matching section and therefore “A” is added to the sections of the video telephone 4 and “B” is added to the sections of the video telephone 5. The video telephones 4 and 5 exchange character data at the telephone conversation start time and thus have character data retention sections 19A and 19B for retaining the character data of the associated party.

FIG. 12 is a flowchart to show the operation of the video telephone 4. First, the video telephone 4 starts conversation with the video telephone 5 (ST50). When the conversation with the video telephone 5 is started, character data CA stored in a character data storage section 15A is transmitted to the video telephone 5 (ST51). After the character data CA is transmitted, reception of character data CB transmitted from the associated video telephone 5 is started (S52). When the character data CB is transmitted, it is stored in the character data retention section 19A (ST53).

After the character data CB is received and is retained, input data IA is acquired (ST54). That is, at least one of image data, voice data, and key input data is acquired from an input data section 10A of the home machine. When the input data IA is acquired, then the expression and emotion of the user of the home machine are analyzed from the input data IA (ST55). For example, if a laughing face of the user is photographed, the analysis result of “laughing” is produced. After the expression and emotion of the user of the home machine are analyzed, action data DA responsive to the expression and emotion of the user of the home machine is generated from the analysis result (ST56). The generated action data DA is transmitted to the associated video telephone 5 (ST57). After the action data DA is transmitted, reception of the action data DB from the associated video telephone 5 is started (ST58).

When the action data DB of the video telephone 5 is acquired, if one of the action data DB and the action data DA of the home terminal is data of mutual action, matching is performed (ST59). If both are data of mutual action, matching is performed so that the action data obtained earlier becomes active action, for example. The details of the matching processing are described later. After the action data DA and DB are matched, a character display image is generated based on the action data DA (ST60) and is displayed on a video telephone display section 14A (ST61). During the telephone conversation (NO at ST62), steps ST54 to ST62 are repeated. When the telephone conversation terminates (YES at ST62), the processing is terminated.

FIG. 13 is a flowchart to show the operation of the action matching section 18A. First, the action matching section 18A starts processing to input the action data DA generated by an action data generation section 17A (ST70) and determines whether or not action data DA exists (ST71). If action data DA is not input (NO at ST71), the action data DA is changed to default action data DA (ST72). In contrast, if action data DA is input (YES at ST71), the input action data DA is transmitted to the associated video telephone 5 (ST73). After the action data DA is transmitted, processing to receive action data DB from the associated video telephone 5 is started (ST74) and whether or not action data DB exists is determined (ST75). If action data DB is not obtained (NO at ST75), the action data DB is changed to default action data DB (ST76).

In contrast, if action data DB is obtained (YES at ST75), the combination priority of the action data DA and DB is determined (ST77). In this case, mutual action takes precedence over sole action and for mutual actions, for example, the mutual action corresponding to the earlier obtained action data is selected. However, if time determination is made, when first communications are started, the video telephones 4 and 5 are synchronized with each other.

After the combination priority of the action data DA and DB is thus determined, the action data DA, DB is changed according to the priority (ST78). That is, as described above, if the action data DA is “laughing” and the action data DB is “thrusting away,” the action data DB of mutual action takes precedence over the action data DA and accordingly, the action data DA of “laughing” is changed to action data DA′ of “blowing off.” After the action data DA, DB is changed, they are output (ST79).

FIG. 14 is a flowchart to show the operation of the video telephone 5. First, the video telephone 5 starts conversation with the video telephone 4 (ST90). When the conversation with the video telephone 4 is started, character data CB stored in a character data storage section 15B is transmitted to the video telephone 4 (ST91). After the character data CB is transmitted, reception of character data CA transmitted from the associated video telephone 4 is started (S92). When the character data CA is transmitted, it is stored in the character data retention section 19B (ST93).

After the character data CA is received and is retained, input data IB is acquired (ST94). That is, at least one of image data, voice data, and key input data is acquired from an input data section 10B of the home terminal. When the input data IB is acquired, then the expression and emotion of the user of the home terminal are analyzed from the input data IB (ST95). For example, if a crying face of the user is photographed, the analysis result of “crying” is produced. After the expression and emotion of the user of the home terminal are analyzed, action data DB responsive to the expression and emotion of the user of the home terminal is generated from the analysis result (ST96). The generated action data DB is transmitted to the associated video telephone 4 (ST97). After the action data DB is transmitted, reception of the action data DA from the associated video telephone 4 is started (ST98).

When the action data DA of the video telephone 4 is acquired, if one of the action data DA and the action data DB of the home terminal is data of mutual action, matching is performed (ST99). If both are data of mutual action, matching is performed so that the action data obtained earlier becomes active action, for example. The details of the matching processing are described later. After the action data DB and DA are matched, a character display image is generated based on the action data DB (ST100) and is displayed on a video telephone display section 14B (ST101). During the telephone conversation (NO at ST102), steps ST94 to ST102 are repeated. When the telephone conversation terminates (YES at ST102), the processing is terminated.

FIG. 15 is a flowchart to show the operation of the action matching section 18B. First, the action matching section 18B starts processing to input the action data DB generated by an action data generation section 17B (ST110) and determines whether or not action data DB exists (ST111). If action data DB is not input (NO at ST111), the action data DB is changed to default action data DB (ST112). In contrast, if action data DB is input (YES at ST111), the input action data DB is transmitted to the associated video telephone 4 (ST113). After the action data DB is transmitted, processing to receive action data DA from the associated video telephone 4 is started (ST114) and whether or not action data DA exists is determined (ST115). If action data DA is not obtained (NO at ST115), the action data DA is changed to default action data DA (ST116).

In contrast, if action data DAis obtained (YES at ST115), the combination priority of the action data DB and DA is determined (ST117). In this case, mutual action takes precedence over sole action and for mutual actions, for example, the mutual action corresponding to the earlier obtained action data is selected. However, if time determination is made, when first communications are started, the video telephones 5 and 4 are synchronized with each other.

After the combination priority of the action data DB and DA is thus determined, the action data DB, DA is changed according to the priority (ST118). That is, if the action data DB is “crying” and the action data DA is “thrusting away,” the action data DA of mutual action takes precedence over the action data DB and accordingly, the action data DB of “crying” is changed to action data DB′ of “blowing off.” After the action data DB, DA is changed, they are output (ST119).

### THIRD EMBODIMENT

FIG. 16 is a schematic configuration diagram of a video telephone system to describe a third embodiment of the invention. The video telephone system shown in FIG. 16 includes video telephones 6 and 7 which have a communication function, install a common function to a function that an associated communication terminal installs, and have the same degree of terminal capability. Parts common to those in FIG. 1 are denoted by the same reference numerals in FIG. 16 and further the video telephone 6 includes an image process data storage section 20 in place of the character data storage section 15, an image process determination section 21 in place of the action data generation section 17, and an action process matching section 22 in place of the action matching section 18 and therefore “A” is added to the sections of the video telephone 6 and “B” is added to the sections of the video telephone 7.

In the embodiment, the display image and the transmission image to be created are process images based on camera input images rather than characters. The video telephone image is made up of images of both the video telephones 6 and 7 and only the video telephone 6 performs all display data combining processing. Only the video telephone 7 mayperform all display data combining processing. FIG. 17 is a drawing to show examples of camera images photographed with the video telephones 6 and 7. FIG. 17(a) shows a camera image PIA provided by photographing the user of the video telephone 6 and FIG. 17(b) shows a camera image PIB provided by photographing the user of the video telephone 7. The camera images PIA and PIB photographed with the video telephones 6 and 7 are displayed in the combined form on a video telephone display section 14A of the video telephone 6 and a video telephone display section 14B of the video telephone 7.

FIG. 18 is a drawing to show examples of action tables usedby the image process determination section 21 and the image process matching section 22. The image process determination section 21 references the tables shown in FIG. 18 based the analysis result of an expression and emotion analysis section 16 and generates image process data responsive to the expressions and emotions of the user of the video telephone 6 and the user of the video telephone 7. FIG. 18(a) is a sole process table TD of the video telephone 6 and FIG. 18(b) is a sole process table TE of the video telephone 7; each shows a set of image process data not affecting the associated image. FIG. 18(c) is a mutual process table TF of the video telephones 6 and 7 and shows a set of image process data affecting the associated image.

The image process determination section 21 generates image process data DPA from the sole process table TD if input data IA of the video telephone 6 indicates sole process; generates image process data DPB from the sole process table TE if input data IB of the video telephone 7 indicates sole process; generates image process data DPA from the mutual process table TF if input data IA of the video telephone 6 indicates mutual action; and generates image process data DPB from the mutual process table TF if input data IB of the video telephone 7 indicates mutual action.

The following image process data is generated by way of example:
(1) If specific key input occurs, image process data for entering a balloon in a camera image is generated.
(2) If the camera image is a laughing face, image process data for entering a heart mark in the camera image is generated.
(3) When the user speaks loudly, image process data for scaling up the camera image is generated.

The image process determination section 21 stores the generated image process data DPA and DPB in the image process data storage section 20.

The image process matching section 22 matches the image processing method from the image process data DPA of the video telephone 6 determined by the image process determination section 21 and stored in the image process data storage section 20 and the image process data DPB of the video telephone 7. For example, when the image process data of the video telephone 6 is “scale up,” the image process data of the video telephone 7 becomes “scale down.”

The image process matching section 22 operates in any of the following four manners depending on the image process data combination:
(1) If the image process data DPA and the image process data DPB are data in the sole process tables TD and TE, the image process data DPA and the image process data DPB are output intact.
(2) If the image process data DPA is data in the sole process table TD and the image process data DPB is data in the mutual process table TF, the image process data DPB takes precedence over the image process data DPA. As the image process data DPB, active action data in the mutual process table TF is output and as the image process data DPA, passive action data corresponding to active action data in the mutual process table TF is output. For example, the image of the user of the video telephone 6 is scaled up and the image of the video telephone 7 is scaled down.
(3) If the image process data DPA is data in the mutual process table TF and the image process data DPB is data in the sole process table TE, the image process matching section 22 operates in a similar manner. For example, the image of the user of the video telephone 6 is scaled up and the image of the video telephone 7 is scaled down.
(4) If both the image process data DPA and the image process data DPB are data in the mutual process table TF, from time information, the earlier determined image process data takes precedence and the data in the mutual process table TF on the superior side is output.

FIG. 19 is a drawing to show an operation outline of the image process matching section 22 in (2) described above. As shown in the figure, before image process matching is performed, the image process data DPA is “heart” and the image process data DPB is “hammer” and the image process data DPB of mutual action takes precedence over the image process data DPA and therefore the image process data DPA of “heart” becomes image process data DPA′ is “lump.”

If no image process data is selected because of no effective input (any of image, voice, or key input), “default” in the sole process table TD, TE is output.

In FIG. 16, a display image generation section 13A generates display data from the camera image and the image process data of the video telephone 6 and the camera image and the image process data of the video telephone 7 matched by the image process matching section 22. The display data generated by the display image generation section 13A is input to the video telephone display section 14A and an image based on the display data is displayed. A data transmission section 11A transmits the display data generated by the display image generation section 13A to the video telephone 7. The video telephone 7 receives the display data transmitted from the data transmission section 11A of the video telephone 6 and displays the display data on the video telephone display section 14B.

FIG. 20 is a flowchart to show the operation of the video telephone 6. First, the video telephone 6 starts conversation with the video telephone 7 (ST130). When the conversation with the video telephone 7 is started, input data IA is acquired from an input data section 1OA (ST131). That is, at least one of image data, voice data, and key input data is acquired. Next, the expression and emotion of the user of the video telephone 6 are analyzed from the acquired input data IA (ST132). For example, if a laughing face of the user of the video telephone 6 is photographed, the analysis result of “laughing” is produced.

After the expression and emotion are analyzed from the input data IA, reception of input data IB from the video telephone 7 is started (ST133). When the input data IB transmitted from the video telephone 7 is received, the expression and emotion of the user of the video telephone 7 are analyzed from the input data IB (ST134). For example, if a crying face of the user of the video telephone 7 is fetched, the analysis result of “crying” is produced. Image process data DPA is determined from the analysis result of the input data IA (ST135) and subsequently image process data DPB is determined from the analysis result of the input data IB (ST136).

After the image process data DPA and DPB are generated, if one of them is data of mutual action, matching is performed (ST137). If both are data of mutual action, matching is performed so that the action data based on the input data occurring earlier becomes active action. After the image process data DPA and DPB are matched, the display images of the characters to be displayed on the video telephone display sections 14A and 14B are generated (ST138). The display image data of the character for the video telephone 7 is transmitted to the video telephone 7 (ST139). After the display image data of the character is transmitted to the video telephone 7, the display image of the character for the video telephone 6 is displayed on the video telephone display section 14A (ST140). During the telephone conversation (NO at ST141), steps ST131 to ST140 are repeated. When the telephone conversation terminates (YES at ST141), the processing is terminated.

FIG. 21 is a flowchart to show the operation of the image process matching section 22. First, the image process matching section 22 receives input of image process data DPA (ST150) and determines whether or not image process data DPA exists (ST151). If image process data DPA does not exist (NO at ST151), the image process data DPA is changed to default image process data DPA (ST152). In contrast, if image process data DPA exists (YES at ST151), input of image process data DPA is received (ST153) and whether or not image process data DPB exists is determined (ST154). If image process data DPB does not exist (NO at ST154), the image process data DPB is changed to default image process data DPB (ST155).

In contrast, if image process data DPB exists (YES at ST154), the combination priority of the image process data DPA and DPB is determined (ST156). In this case, mutual process takes precedence over sole process and for mutual processes, for example, the mutual process corresponding to the earlier acquired input data is selected. After the combination priority of the image process data DPA and DPB is determined, the image process data DPA, DPB is changed according to the priority (ST157). That is, as described above, if the image process data DPA is “heart” and the image process data DPB is “hummer,” the image process data DPB of mutual action takes precedence over the image process data DPA and accordingly, the image process data DPA is “heart” is changed to image process data DPA′ of “lump.” After the image process data DPA, DPB is changed, they are output (ST158).

FIG. 22 is a flowchart to show the operation of the video telephone 7. First, the video telephone 7 starts conversation with the video telephone 6 (ST160). When the conversation with the video telephone 6 is started, input data IB is acquired from the input data section 10B (ST161). That is, at least one of image data, voice data, and key input data is acquired. Next, the acquired input data IB is transmitted to the video telephone 6 (ST162). After the input data IB is transmitted to the video telephone 6, display image data subjected to image processing is received (ST163). If the display image data transmitted from the video telephone 6 can be received, the display image data is displayed on the video telephone display section 14B (ST164). During the telephone conversation (NO at ST165), steps ST161 to ST165 are repeated. When the telephone conversation terminates (YES at ST165), the processing is terminated.

While the invention has been described in detail with reference to the specific embodiments, it will be obvious to those skilled in the art that various changes and modifications can be made without departing from the spirit and the scope of the invention.

The present application is based on Japanese Patent Application No. (2004-112854) filed on Apr. 7, 2004 and Japanese Patent Application No. (2005-086335) filed on Mar. 24, 2005, which are incorporated herein by reference.

### INDUSTRIAL APPLICABILITY

The invention has the advantage that the data to execute the function that the home terminal installs and the data to execute the function that the associated communication terminal installs are generated, whereby if the terminal capability of the associated communication terminal is lower than that of the home terminal, the associated communication terminal can be caused to execute the function at the level required by the home terminal, and is useful for a communication terminal having a communication function and installing a common function to a function that an associated communication terminal installs and a communication method of the communication terminal, etc.

1. A communication terminal having a communication function and installing a common function to a function that an associated communication terminal installs, the communication terminal comprising:
a data generation unit which generates data to execute the function that the home terminal installs and data to execute the function that the associated communication terminal installs; and
a transmission unit which transmits the data to execute the function that the associated communication terminal installs.

2. The communication terminal according to claim 1, which has a video telephone function, the communication terminal further comprising;
an input data analysis unit which analizes input data; and
a data matching unit which outputs data provided by matching the data of the home terminal and the data of the associated communication terminal based on the analysis result to the input data analysis unit.

3. The communication terminal according to claim 2, further comprising:
an input unit which inputs at least one data selected from among image data, voice data, and key input data to the input data analysis unit as the input data.

4. A communication method of a communication terminal installing a common function to a function that an associated communication terminal installs, the communication method comprising the steps of:
generating data to execute the function that the home terminal installs and data to execute the function that the associated communication terminal installs; and
transmitting the data to execute the function that the associated communication terminal installs.
